(19) United States
(12) Patent Application Publication
(10) Pub. No.: US 2026/0099353 A1
(43) Pub. Date: Apr. 9, 2026

(54) TASK SCHEDULING

(71) Applicant: BEIJING OCEANBASE TECHNOLOGY CO., LTD., Hangzhou (CN)

(72) Inventors: Haosheng HU, Hangzhou (CN); Jingkun FENG, Hangzhou (CN)

(21) Appl. No.: 19/417,127

(22) Filed: Dec. 11, 2025

Related U.S. Application Data
(63) Continuation of application No. PCT/CN2024/112049, filed on Aug. 14, 2024.

(30) Foreign Application Priority Data
Sep. 27, 2023 (CN) 202311267520.4

(51) Int. Cl. G06F 9/48; G06F 9/50

(52) U.S. Cl. CPC G06F 9/4831; G06F 9/5016

(57) ABSTRACT

One or more implementations of the present specification provide a task scheduling method and apparatus, and relate to the field of computer technologies. The method includes: determining a target task queue from a plurality of pre-constructed task queues, the plurality of pre-constructed task queues being used respectively to store tasks with different priorities, each task queue having a respective scheduling weight, and the scheduling weight being used to control a probability that the task queue is determined as the target task queue; and scheduling a target task in the target task queue to a specified thread in a thread pool, to execute the target task. In the implementations of the present specification, execution of tasks with different priorities can be properly coordinated, thereby avoiding resource contention among the tasks with different priorities in a task scheduling process.

### TECHNICAL FIELD

One or more implementations of the present specification relate to the field of computer technologies, and in particular, to a task scheduling method and apparatus.

### BACKGROUND

Task scheduling is a process of allocating a to-be-executed task to an available thread in a thread pool based on a determined resource allocation strategy. Through proper task scheduling in a system, various tasks can be efficiently executed in the system, and stability, responsiveness, and performance of the system can be ensured while task execution requirements are satisfied.

### SUMMARY

One or more implementations of the present specification provide a task scheduling method and apparatus.

One or more implementations of the present specification provide the following technical solutions.

According to a first aspect of one or more implementations of the present specification, a task scheduling method is provided, including: determining a target task queue from a plurality of pre-constructed task queues, the plurality of pre-constructed task queues being used respectively to store tasks with different priorities, each task queue having a respective scheduling weight, and the scheduling weight being used to control a probability that the task queue is determined as the target task queue; and scheduling a target task in the target task queue to a specified thread in a thread pool, to execute the target task.

According to a second aspect of one or more implementations of the present specification, a task scheduling apparatus is provided, including: a determining module, configured to determine a target task queue from a plurality of pre-constructed task queues, the plurality of pre-constructed task queues being used respectively to store tasks with different priorities, each task queue having a respective scheduling weight and the scheduling weight being used to control a probability that the task queue is determined as the target task queue; and a scheduling module, configured to schedule a target task in the target task queue to a specified thread in a thread pool, to execute the target task.

According to a third aspect of one or more implementations of the present specification, an electronic device is provided, including: a processor; and a storage, configured to store processor-executable instructions. The processor runs the executable instructions to implement the method according to the first aspect.

According to a fourth aspect of one or more implementations of the present specification, a computer-readable storage medium is provided. The computer-readable storage medium stores computer instructions, and when the instructions are executed by a processor, the steps of the method according to the first aspect are implemented.

According to the method provided in the present specification, a plurality of task queues are pre-constructed. The plurality of pre-constructed task queues are used respectively to store tasks with different priorities. Each task queue has a respective scheduling weight, and the scheduling weight is used to control a probability that the task queue is determined as the target task queue. By determining a different task queue as the target task queue each time, scheduling of tasks with different priorities can be implemented. Because the probability that the task queue is determined as the target task queue can be controlled by using the scheduling weight, a frequency at which a task in each task queue is scheduled can be controlled by configuring the scheduling weight, so that the tasks with different priorities are scheduled at different frequencies. Therefore, in the implementations of the present specification, execution of tasks with different priorities can be properly coordinated, thereby avoiding resource contention among the tasks with different priorities in a task scheduling process.

### BRIEF DESCRIPTION OF DRAWINGS

FIG. 1 is a schematic flowchart illustrating a task scheduling method according to an example implementation;

FIG. 2 is a schematic flowchart illustrating a method for determining a total quantity of threads according to an example implementation;

FIG. 3 is a schematic structural diagram illustrating a device according to an example implementation; and

FIG. 4 is a schematic structural diagram illustrating a task scheduling apparatus according to an example implementation.

### DESCRIPTION OF IMPLEMENTATIONS

Example implementations are described in detail herein, and examples of the example implementations are presented in the accompanying drawings. When the following descriptions relate to the accompanying drawings, unless specified otherwise, the same numbers in different accompanying drawings represent the same or similar elements. Implementations described in the following example implementations do not represent all implementations consistent with one or more implementations of the present specification. On the contrary, the implementations are merely examples of apparatuses and methods described in detail in the appended claims and consistent with some aspects of one or more implementations of the present specification.

It should be noted that in other implementations, the steps of the corresponding method are not necessarily performed in the sequence shown and described in the present specification. In some other implementations, the method can include more or fewer steps than those described in the present specification. In addition, a single step described in the present specification may be broken down into a plurality of steps in other implementations for description, and a plurality of steps described in the present specification may be combined into a single step in other implementations for description.

With the development of computer technologies, task scheduling processes are common in various computer systems. A database system is used as an example. In a log-structured merge tree (LSM tree)-based database system, a compaction task is a typical task for scheduling. Compaction tasks include a dump task or a merge task, both of which are resource-intensive tasks in the database system. Therefore, in a process of executing the dump task and/or the merge task, not only a resource requirement for executing the task needs to be considered, but also impact of an allocated resource on another module task in the system needs to be considered. In some implementations, a task scheduling strategy is configured to manage resources.

In related technologies, due to differences in data processing volumes and features among different types of tasks, allocating resources based only on resource utilization of the system may lead to a waste and affect resource usage of other module tasks. In addition, for tasks with different priorities, execution of the tasks with different priorities cannot be effectively balanced in the related technologies. When a priority is considered, a task with a low priority is suspended for a long time, and when a priority is not considered, a task with a high priority cannot be preferentially executed, leading to resource contention among the tasks with different priorities.

In some implementations of the present specification, a plurality of task queues are pre-constructed. The plurality of pre-constructed task queues are used respectively to store tasks with different priorities. Each task queue has a respective scheduling weight, and the scheduling weight is used to control a probability that the task queue is determined as the target task queue. By determining a different task queue as the target task queue each time, scheduling of tasks with different priorities can be implemented. Because the probability that the task queue is determined as the target task queue can be controlled by using the scheduling weight, a frequency at which a task in each task queue is scheduled can be controlled by configuring the scheduling weight, so that the tasks with different priorities are scheduled at different frequencies. Therefore, in the implementations of the present specification, execution of tasks with different priorities can be properly coordinated, thereby avoiding resource contention among the tasks with different priorities in a task scheduling process.

For ease of understanding, the following uses scheduling of a compaction task in a distributed database as an example to first describe an application scenario of the implementations of the present specification.

As described above, the compaction task is a typical task in an LSM tree-based database system. The LSM tree-based database system usually includes a memory table (MemTable) and a sorted string table (SSTable).

The MemTable is an in-memory data structure in the LSM tree. Because the MemTable is stored in memory, a data read/write operation in the MemTable can be efficiently performed. When a write operation in the database occurs, to-be-written data is first written into the MemTable to maintain fast write performance. However, due to a limited memory capacity, when a size of the MemTable reaches a specific threshold, data stored in the MemTable is dumped into the SSTable on a hard disk, to release storage space in the memory for new data writes.

The SSTable is a disk-based data structure in the LSM tree, and is used for data persistence. For example, when data in the MemTable is dumped into the hard disk, the data is written into the SSTable. When a plurality of SSTables accumulate to a specific quantity or size, the plurality of SSTables can be merged into a larger SSTable file, to reduce occupation of hard disk space and optimize read performance.

The above dump and merge tasks are respectively different types of compaction tasks. Because occupied memory in the database system can be released through dumping, and a dumping process may affect execution of a database foreground SQL statement, a priority of the dump task is usually higher than that of the merge task. According to the task scheduling method provided in the implementations of the present specification, execution of the above dump task and merge task can be effectively coordinated. This avoids long-term suspension of the merge task while ensuring preferential execution of the dump task.

The following describes an example implementation of the present specification in detail with reference to the above application scenario.

First, some implementations of the present specification provides a task scheduling method. The method can be performed by any electronic device.

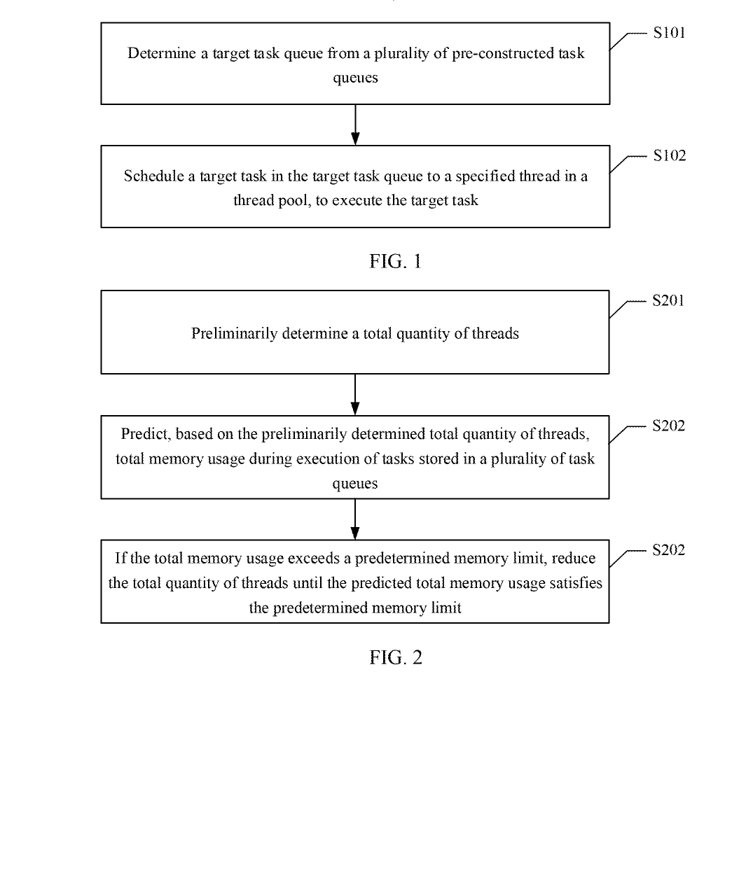

FIG. 1 is a schematic flowchart illustrating a task scheduling method according to an example implementation. As shown in FIG. 1, the task scheduling method provided in some implementations of the present specification includes the following steps.

S101: Determine a target task queue from a plurality of pre-constructed task queues.

It should be noted that the task queue is a container used to store a task. A plurality of task queues are preconfigured in the present specification, and the plurality of pre-constructed task queues are used respectively to store tasks with different priorities.

For example, in the above application scenario, compaction tasks can be classified into two task types with different priorities, e.g., dump and merge. Because a priority of the dump task is higher than that of the merge task, respective subtasks of the dump task and the merge task can be respectively stored in different task queues.

In addition, each task queue further has a respective scheduling weight, and the scheduling weight is used to control a probability that the task queue is determined as the target task queue. By adjusting the scheduling weight, a probability that a task queue in which a task with a high priority is located is determined as the target task queue can be increased, or a probability that a task queue in which a task with a low priority is located is determined as the target task queue can be reduced.

For example, after the scheduling weight is configured, the probability that the task queue is determined as the target task queue is positively correlated with a priority of a task stored in the task queue.

Because a scheduler schedules a task in the target task queue to a corresponding thread each time, by controlling the probability that the task queue is determined as the target task queue, frequencies at which tasks with different priorities are scheduled can be indirectly controlled.

In some implementations, the scheduling weight is configured by using a weight coefficient interval, and a size of the weight coefficient interval corresponding to each task queue is positively correlated with a priority of a task stored in the task queue, e.g., a higher priority of the task stored in the task queue indicates a larger weight coefficient interval corresponding to the task queue.

After the weight coefficient interval is configured for each task queue, a random weight coefficient can be generated; and a task queue corresponding to a weight coefficient interval within which the random weight coefficient falls can be determined as the target task queue.

For example, it is assumed that there are four task queues A, B, C, and D with different priorities, and priorities of the four task queues are the task queue A>the task queue B>the task queue C>the task queue D. In this case, weight coefficient intervals respectively corresponding to the four task queues A, B, C, and D can be configured as [1, 4], [5, 7], [8, 9], and [10, 10].

When the target task queue is determined, a random number between 1 and 10 is generated; and a task queue corresponding to a weight coefficient interval within which the random number falls can be determined as the target task queue.

Therefore, in some implementations of the present specification, tasks with different priorities are respectively stored in different task queues, and a different scheduling weight is assigned to each task queue based on a priority of the task, to effectively control frequencies at which the tasks with different priorities are scheduled. Therefore, long-term suspension of a task with a low priority is avoided while preferential scheduling of a task with a high priority is ensured.

S102: Schedule a target task in the target task queue to a thread in a thread pool, to execute the target task.

It should be noted that the target task is a task that is in the target task queue and does not depend on an execution result of another task. For example, tasks in each task queue can be pre-constructed into a directed acyclic graph (DAG), and the DAG is used to show a dependency relationship between the tasks in the task queue.

If there are a plurality of tasks that satisfy this condition in the target task queue, scheduling can be performed based on a "first in first out" rule in the queue. For example, a task stored in the task queue earlier is preferentially scheduled.

For example, the above compaction task is still used as an example. Several subtasks need to be scheduled during execution of the compaction task. Because subtasks of the same compaction task have a same priority, these subtasks are stored in the same task queue. There may be three types of subtasks in the subtasks of the compaction task. A first type of subtask is used to select to-be-merged SSTables, a second type of subtask is used to organize the to-be-merged SSTables and form a new macroblock, and a third type of subtask is used to generate an SSTable structure based on the new macroblock. In the three types of subtasks, the first type of subtask does not depend on an execution result of another task, and can be independently executed. The second type of subtask depends on an execution result of the first type of subtask, and the third type of subtask depends on an execution result of the second type of subtask.

Therefore, a DAG corresponding to the task queue can be pre-constructed based on a dependency relationship between the three types of subtasks, so that tasks in the task queue are scheduled in a sequence of the first type of subtask, the second type of subtask, and the third type of subtask.

It should be noted that the thread pool is a thread management mechanism. The thread pool maintains a thread set, and includes a plurality of reusable threads. After a task is scheduled to a thread in the thread pool, the thread executes the scheduled task, and continues to wait for next task scheduling after execution of the task is completed. The same thread cannot simultaneously execute a plurality of tasks.

As described above, the task with a high priority has a relatively high scheduling probability. Therefore, to avoid a case in which excessive system resources (for example, threads and memory) are preempted because the task with a high priority is continuously scheduled, in some implementations of the present specification, threads in the thread pool are further distinguished, and a specific thread is restricted to execution only of a task with a specific priority.

In some implementations of the present specification, the threads in the thread pool are classified into at least a first thread and a second thread. The first thread and the second thread are used respectively to execute tasks with different priorities. Certainly, to precisely control resources that can be occupied by tasks with different priorities, the threads in the thread pool can be more precisely classified, for example, are classified into the first thread, the second thread, and a third thread, and different threads are used respectively to execute tasks with different priorities. This is not limited in some implementations of the present specification.

When the threads are classified into the first thread and the second thread, scheduling of the task with a low priority and simplicity of a thread classification process can be effectively balanced. In this case, the first thread is used to execute a task with a highest priority stored in the plurality of pre-constructed task queues, and the second thread is used to execute a task with a priority other than the highest priority stored in the plurality of pre-constructed task queues.

For example, in some implementations of the present specification, the first thread is used as a dedicated thread for the task with the highest priority, and the second thread is reserved as a dedicated thread for a task with another priority, to avoid a case in which a task with a certain priority is heavily scheduled and consequently a resource of a task with another priority is preempted.

In some implementations, a quantity of first threads is less than or equal to a quantity of second threads. Considering that the first thread is a dedicated thread for executing the task with the highest priority, and there are usually a relatively small quantity of tasks with the highest priority and a high scheduling frequency, a quantity of threads reserved for the task with the highest priority can be less than or equal to a quantity of threads used to execute the task with another priority.

For example, the quantity of first threads can be 40% of a total quantity of threads in the thread pool, the quantity of second threads can be 60% of the total quantity of threads in the thread pool, and the quantity of first threads and the quantity of second threads are at least 1, to avoid a case in which there is no thread that can execute a task with a specific priority in the thread pool.

Therefore, in S102, the target task can be scheduled to the first thread or the second thread based on a priority of the target task.

In some implementations, after the total quantity of threads in the thread pool is determined, at least half of the total quantity of threads in the thread pool can be configured as second threads, and the remaining threads are used as the first threads, thereby completing configuration of the threads in the thread pool.

For ease of understanding, the following describes, with reference to FIG. 2, in detail a method for determining a total quantity of threads in some implementations of the present specification.

FIG. 2 is a schematic flowchart illustrating a method for determining a total quantity of threads according to an example implementation. As shown in FIG. 2, the method for determining a total quantity of threads provided in some implementations of the present specification includes the following steps.

S201: Preliminarily determine the total quantity of threads.

In some implementations, the total quantity of threads can be preliminarily determined based on system resources. For example, the quantity of threads is directly correlated with CPU performance. Therefore, the total quantity of threads in the thread pool can be preliminarily determined based on a quantity of CPU cores that can be currently invoked by a user, so that the total quantity of threads is positively correlated with the quantity of CPU cores.

S202: Predict, based on the preliminarily determined total quantity of threads, total memory usage during execution of tasks stored in the plurality of pre-constructed task queues.

In some implementations, each thread needs to occupy a specific amount of memory when executing a task. Therefore, after the total quantity of threads is preliminarily determined, the total memory usage during execution of the tasks stored in the plurality of pre-constructed task queues can be predicted based on memory occupied by each thread in an actual task.

It should be noted that because a task type stored in the task queue is uncertain, during execution of these tasks, in addition to the memory occupied by each thread, other memory may be occupied. When the total memory usage is predicted, all memory that may be occupied during execution of the tasks should be considered.

S203: If the total memory usage exceeds a predetermined memory limit, reduce the total quantity of threads until the predicted total memory usage satisfies the predetermined memory limit.

In some implementations, the predetermined memory limit can be a predetermined memory percentage. For example, the total memory usage is limited to no more than 60% of current free memory. If the memory percentage is exceeded, the total quantity of threads can be reduced, and a corresponding total memory usage rate can be re-predicted, until the predicted total memory usage satisfies the predetermined memory limit.

The following uses execution of a plurality of compaction tasks as an example to describe a relationship between the total memory usage and the total quantity of threads. In this case, a subtask of each compaction task is stored in each of the plurality of pre-constructed task queues.

It can be understood that memory occupied in a process of the compaction task mainly includes the following four parts.

1. Macroblock buffer memory (buffer_mem): One compaction task needs to apply for nine 2 MB memory blocks from a global memory pool, and these memory blocks are used to store data that needs to be invoked during execution of the compaction task. When a total quantity of memory blocks applied for by all the compaction tasks exceeds a quantity of free blocks, a doubling expansion mechanism doubles space of the memory pool. Therefore, if a total quantity of compaction tasks is C, usage of buffer_mem is expected to be 18 MB×C.

2. Macroblock meta information memory (meta_mem): During execution of the compaction task, when a macroblock is written into a disk, a deep copy of meta information of the macroblock is needed, and a quantity of copies is a quantity of macroblocks flushed. The meta information of the macroblock includes basic information (of a fixed size) and a row of row keys. A larger quantity of macroblocks (e.g., a larger data volume) or a larger quantity of row key columns indicates a larger amount of memory occupied. If the fixed size of the basic information of the meta information of the macroblock is mem_size, the quantity of macroblocks is N, a quantity of row key columns is M, and an average size of the columns is S, usage of meta_mem is expected to be N×(meta_size+M×S).

3. Deep copy memory (rowkey_mem): During execution of the compaction task, when row data is written into a macroblock, a deep copy of a row key is needed. Each time the macroblock is flushed, the memory is reused. Therefore, actual memory consumption of this part is correlated with a quantity of rows in the macroblock. If a quantity of row key columns is M, the macroblock includes N rows, and an average size of the row key columns is S, usage of rowkey_mem is expected to be N×(M×S).

4. Prestored array (static_mem): During execution of the compaction task, some relatively large fixed-length arrays (usually 8 MB) and dynamic arrays are further prestored, and these arrays occupy a specific amount of memory. If R is estimated memory of the dynamic arrays, usage of static_mem is expected to be 8 MB+R.

During actual execution of the compaction task, each compaction task uses buffer_mem and meta_mem, and each thread used to execute the subtask of the compaction task uses rowkey_mem and static_mem.

Therefore, if there are a total of C compaction tasks and the total quantity of threads is K, the total memory usage of the compaction tasks is total_mem=K×(rowkey_mem+static_mem)+C×(meta_mem+buffer_mem).

If the total memory usage exceeds the predetermined memory limit, the total quantity K of threads can be appropriately reduced, so that the total memory usage rate satisfies the predetermined memory limit.

For example, when a subtask of each compaction task is stored in each of the plurality of pre-constructed task queues, S202 can include the following steps: separately predicting macroblock buffer memory usage, macroblock meta information memory usage, deep copy memory usage, and prestored array memory usage that are generated during execution of the compaction task; multiplying a sum of the macroblock buffer memory usage and the macroblock meta information memory usage by a quantity of compaction tasks, to obtain a first product; multiplying a sum of the deep copy memory usage and the prestored array memory usage by the preliminarily determined total quantity of threads, to obtain a second product; and adding the first product and the second product to obtain the total memory usage.

In some implementations, a total quantity of threads that can be fully used under the predetermined memory limit of the total memory usage total_mem can be inferred based on the predetermined memory limit, and a smaller value in the total quantity of threads inferred based on the predetermined memory limit and the preliminarily determined total quantity of threads in S201 is used as a finally determined total quantity of threads, to avoid a case in which the total quantity of threads exceeds a maximum quantity of threads actually available in the task execution process and consequently a resource waste is caused.

In some implementations of the present specification, resources that need to be consumed in the task execution process can be properly determined, and these resources are allocated and occupied. This can avoid, while ensuring preferential scheduling of the task with a high priority, a case in which the task with another priority is suspended for a long term or cannot be executed due to a lack of resources. In addition, in some implementations of the present specification, a relationship between a thread and memory usage is established, so that system resources can be fully used, and a resource waste caused by configuring an excessively large quantity of threads or occupying an excessively large amount of memory is avoided.

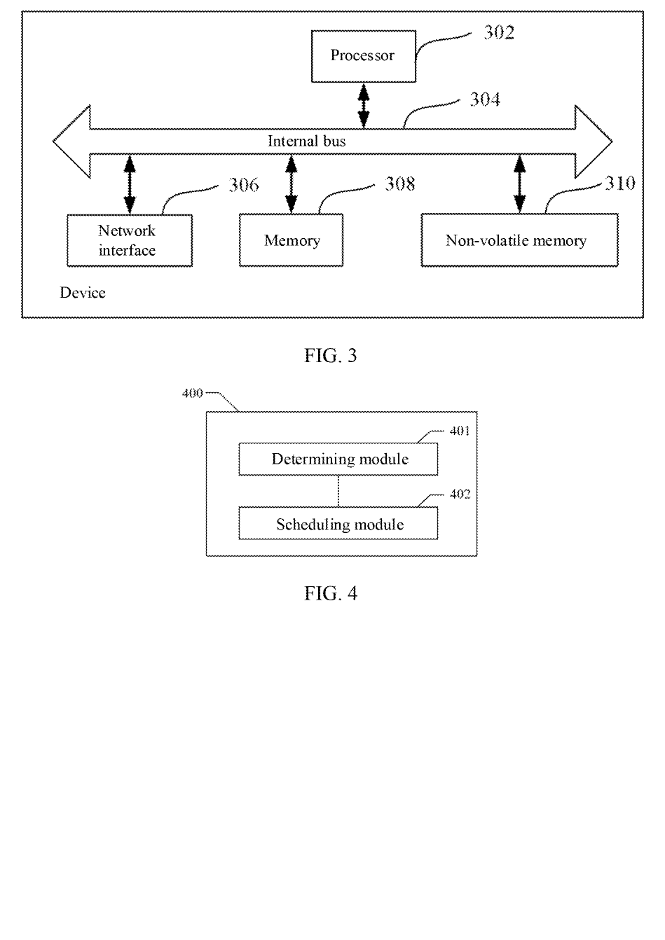

FIG. 3 is a schematic structural diagram illustrating a device according to an example implementation. Referring to FIG. 3, in terms of hardware, the device includes a processor 302, an internal bus 304, a network interface 306, a memory 308, and a non-volatile memory 310, and certainly may further include hardware needed for another function. One or more implementations of the present specification can be implemented in a software-based manner. For example, the processor 302 reads a corresponding computer program from the non-volatile memory 310 into the memory 308, and then runs the computer program. Certainly, in addition to a software implementation, one or more implementations of the present specification do not exclude another implementation, for example, a logic device or a combination of hardware and software. For example, an execution body of the following processing procedure is not limited to each logical unit, and can be hardware or a logic device.

FIG. 4 provides a task scheduling apparatus 400, which can be applied to the device shown in FIG. 3 to implement the technical solutions of the present specification. Specifically, the task scheduling apparatus 400 can include the following modules.

A determining module 401 is configured to determine a target task queue from a plurality of pre-constructed task queues. The plurality of pre-constructed task queues are used respectively to store tasks with different priorities. Each task queue has a respective scheduling weight, and the scheduling weight is used to control a probability that the task queue is determined as the target task queue.

A scheduling module 402 is configured to schedule a target task in the target task queue to a specified thread in a thread pool, to execute the target task.

In some implementations, the thread pool includes a first thread and a second thread, and the first thread and the second thread are used respectively to execute tasks with different priorities. The scheduling module 402 is specifically configured to schedule the target task to the first thread or the second thread based on a priority of the target task.

In some implementations, the first thread is used to execute a task with a highest priority stored in the plurality of pre-constructed task queues, the second thread is used to execute a task with a priority other than the highest priority stored in the plurality of pre-constructed task queues, and a quantity of first threads is less than or equal to a quantity of second threads.

In some implementations, the task scheduling apparatus 400 further includes a thread determining module (not shown in the figure). The thread determining module is configured to: determine a total quantity of threads in the thread pool; and configure at least half of the total quantity of threads in the thread pool as second threads.

In some implementations, the thread determining module is further configured to: preliminarily determine the total quantity of threads; predict, based on the preliminarily determined total quantity of threads, total memory usage during execution of tasks stored in the plurality of pre-constructed task queues; and if the total memory usage exceeds a predetermined memory limit, reduce the total quantity of threads until the predicted total memory usage satisfies the predetermined memory limit.

In some implementations, the tasks stored in the plurality of pre-constructed task queues are subtasks of a compaction task. The thread determining module is further configured to: separately predict macroblock buffer memory usage, macroblock meta information memory usage, deep copy memory usage, and prestored array memory usage that are generated during execution of the compaction task; multiply a sum of the macroblock buffer memory usage and the macroblock meta information memory usage by a quantity of compaction tasks, to obtain a first product; multiply a sum of the deep copy memory usage and the prestored array memory usage by the preliminarily determined total quantity of threads, to obtain a second product; and add the first product and the second product to obtain the total memory usage.

In some implementations, the probability that the task queue is determined as the target task queue is positively correlated with a priority of a task stored in the task queue.

In some implementations, the scheduling weight is configured by using a weight coefficient interval, and a size of the weight coefficient interval corresponding to each task queue is positively correlated with a priority of a task stored in the task queue. The determining module 401 is specifically configured to: generate a random weight coefficient; and determine a task queue corresponding to a weight coefficient interval within which the random weight coefficient falls as the target task queue.

The systems, apparatuses, modules, or units described in the above implementations can be specifically implemented by a computer chip or an entity, or can be implemented by a product having a certain function. A typical implementation device is a computer, and a specific form of the computer can be a personal computer, a laptop computer, a cellular phone, a camera phone, a smartphone, a personal digital assistant, a media player, a navigation device, an email receiving/sending device, a game console, a tablet computer, a wearable device, or any combination of several devices in these devices.

In a typical configuration, the computer includes one or more processors (CPUs), an input/output interface, a network interface, and one or more memory devices.

The memory may include a non-persistent memory, a random access memory (RAM), a non-volatile memory, and/or another form in a computer-readable medium, for example, a read-only memory (ROM) or a flash memory (flash RAM). The memory is an example of the computer-readable medium.

The one or more processors can individually or collectively execute computer instructions to implement actions. When multiple processors execute the computer instructions, the processors may execute the same instructions as one another or different instructions from one another. The processors may implement the same actions as one another or implement different actions from one another, e.g., of the methods described herein, in a collective way.

The computer-readable medium includes persistent, non-persistent, removable, and non-removable media that can store information by using any method or technology. The information can be computer-readable instructions, a data structure, a program module, or other data. Examples of the computer storage medium include but are not limited to a phase change random access memory (PRAM), a static random access memory (SRAM), a dynamic random access memory (DRAM), another type of random access memory (RAM), a read-only memory (ROM), an electrically erasable programmable read-only memory (EEPROM), a flash memory or another memory technology, a compact disc read-only memory (CD-ROM), a digital versatile disc (DVD) or another optical storage, a cassette magnetic tape, a magnetic disk storage, a quantum memory, a graphene-based storage medium, another magnetic storage device, or any other non-transmission medium. The computer storage medium can be configured to store information that can be accessed by a computing device. Based on the definition in the present specification, the computer-readable medium does not include transitory computer-readable media, for example, a modulated data signal and carrier.

The one or more memory devices may be configured to individually or collectively store computer executable instructions to enable the methods provided herein. When the one or more memory devices collectively store computer executable instructions, they may or may not store the same instruction or same part of an instruction at a same time and they may store different instructions or different parts of an instruction collectively.

It should be further noted that the terms "include", "comprise", or any other variants thereof are intended to cover a non-exclusive inclusion, so that a process, a method, a product, or a device that includes a list of elements not only includes those elements but also includes other elements which are not expressly listed, or further includes elements inherent to such a process, method, product, or device. Without more constraints, an element preceded by "includes a …" does not preclude the presence of additional identical elements in the process, method, product, or device that includes the element.

Specific implementations of the present specification are described above. Other implementations fall within the scope of the appended claims. In some cases, the actions or steps described in the claims can be performed in a sequence different from that in the implementations and the desired results can still be achieved. In addition, the process depicted in the accompanying drawings does not necessarily need a particular sequence or a consecutive sequence to achieve the desired results. In some implementations, multi-tasking and parallel processing are feasible or may be advantageous.

The terms used in one or more implementations of the present specification are merely used to describe specific implementations, and are not intended to limit the one or more implementations of the present specification. The terms "a" and "the" of singular forms used in one or more implementations of the present specification and the appended claims are also intended to include plural forms, unless otherwise specified in the context clearly. It should be further understood that the term "and/or" used in the present specification indicates and includes any or all possible combinations of one or more associated listed items.

It should be understood that although terms "first", "second", "third", etc. may be used in one or more implementations of the present specification to describe various types of information, the information should not be limited to these terms. These terms are merely used to distinguish between information of the same type. For example, without departing from the scope of one or more implementations of the present specification, first information can also be referred to as second information, and similarly, the second information can also be referred to as the first information. Depending on the context, for example, the word "if" used herein can be explained as "while", "when", or "in response to determining".

The above descriptions are merely example implementations of one or more implementations of the present specification, but are not intended to limit the one or more implementations of the present specification. Any modification, equivalent replacement, improvement, etc. made without departing from the spirit and principle of the one or more implementations of the present specification shall fall within the protection scope of the one or more implementations of the present specification.

What is claimed is:

1. A task scheduling method, comprising: determining a target task queue from a plurality of task queues, the plurality of task queues configured to respectively store tasks with different priorities, each task queue having a respective scheduling weight, and the scheduling weight related to a probability that the task queue is determined as the target task queue; and scheduling a target task in the target task queue to a thread in a thread pool, to execute the target task.

2. The method according to claim 1, wherein the thread pool includes a first thread and a second thread, and the first thread and the second thread are configured respectively to execute tasks with different priorities; and the scheduling the target task in the target task queue to the thread in the thread pool includes: scheduling the target task to one of the first thread or the second thread based on a priority of the target task.

3. The method according to claim 2, wherein the first thread is configured to execute a task with a highest priority stored in the plurality of task queues, the second thread is configured to execute a task with a priority other than the highest priority stored in the plurality of task queues, and a quantity of the first thread is less than or equal to a quantity of the second thread.

4. The method according to claim 2, further comprising: determining a total quantity of the plurality of threads in the thread pool; and configuring at least half of the plurality of threads in the thread pool as second threads.

5. The method according to claim 4, wherein the determining the total quantity of the plurality of threads in the thread pool includes: preliminarily determining the total quantity of the plurality of threads; predicting, based on the total quantity of threads preliminarily determined, a total memory usage during execution of tasks stored in the plurality of task queues; and in response to the total memory usage exceeding a memory limit, reducing the total quantity of the plurality of threads until the total memory usage predicted satisfies the memory limit.

6. The method according to claim 5, wherein the tasks stored in the plurality of pre-constructed task queues are subtasks of a compaction task; and the predicting, based on the total quantity of threads preliminarily determined, the total memory usage during execution of the tasks stored in the plurality of pre-constructed task queues includes: separately predicting macroblock buffer memory usage, macroblock meta information memory usage, deep copy memory usage, and prestored array memory usage that are generated during execution of the compaction task; multiplying a sum of the macroblock buffer memory usage and the macroblock meta information memory usage by a quantity of the compaction task, to obtain a first product; multiplying a sum of the deep copy memory usage and the prestored array memory usage by the total quantity of threads preliminarily determined, to obtain a second product; and adding the first product and the second product to obtain the total memory usage.

7. The method according to claim 1, wherein the probability that the task queue is determined as the target task queue is positively correlated with a priority of a task stored in the task queue.

8. The method according to claim 1, wherein the scheduling weight is configured by using a weight coefficient interval, and a size of the weight coefficient interval corresponding to each task queue is positively correlated with a priority of a task stored in the task queue; and the determining the target task queue from the plurality of task queues includes: generating a random weight coefficient; and determining a task queue corresponding to a weight coefficient interval within which the random weight coefficient falls as the target task queue.

9. An electronic device, comprising: one or more processors; and one or more storage devices, individually or collectively having computer executable instructions stored thereon, the computer executable instructions, when executed by the one or more processors, enabling the one or more processors to, individually or collectively, implement acts including: determining a target task queue from a plurality of task queues, the plurality of task queues configured to respectively store tasks with different priorities, each task queue having a respective scheduling weight, and the scheduling weight related to a probability that the task queue is determined as the target task queue; and scheduling a target task in the target task queue to a thread in a thread pool, to execute the target task.

10. The electronic device according to claim 9, wherein the thread pool includes a first thread and a second thread, and the first thread and the second thread are configured respectively to execute tasks with different priorities; and the scheduling the target task in the target task queue to the thread in the thread pool includes: scheduling the target task to one of the first thread or the second thread based on a priority of the target task.

11. The electronic device according to claim 10, wherein the first thread is configured to execute a task with a highest priority stored in the plurality of task queues, the second thread is configured to execute a task with a priority other than the highest priority stored in the plurality of task queues, and a quantity of the first thread is less than or equal to a quantity of the second thread.

12. The electronic device according to claim 10, wherein the acts include: determining a total quantity of the plurality of threads in the thread pool; and configuring at least half of the plurality of threads in the thread pool as second threads.

13. The electronic device according to claim 12, wherein the determining the total quantity of the plurality of threads in the thread pool includes: preliminarily determining the total quantity of the plurality of threads; predicting, based on the total quantity of threads preliminarily determined, a total memory usage during execution of tasks stored in the plurality of task queues; and in response to the total memory usage exceeding a memory limit, reducing the total quantity of the plurality of threads until the total memory usage predicted satisfies the memory limit.

14. The electronic device according to claim 13, wherein the tasks stored in the plurality of pre-constructed task queues are subtasks of a compaction task; and the predicting, based on the total quantity of threads preliminarily determined, the total memory usage during execution of the tasks stored in the plurality of pre-constructed task queues includes: separately predicting macroblock buffer memory usage, macroblock meta information memory usage, deep copy memory usage, and prestored array memory usage that are generated during execution of the compaction task; multiplying a sum of the macroblock buffer memory usage and the macroblock meta information memory usage by a quantity of the compaction task, to obtain a first product; multiplying a sum of the deep copy memory usage and the prestored array memory usage by the total quantity of threads preliminarily determined, to obtain a second product; and adding the first product and the second product to obtain the total memory usage.

15. The electronic device according to claim 9, wherein the probability that the task queue is determined as the target task queue is positively correlated with a priority of a task stored in the task queue.

16. The electronic device according to claim 9, wherein the scheduling weight is configured by using a weight coefficient interval, and a size of the weight coefficient interval corresponding to each task queue is positively correlated with a priority of a task stored in the task queue; and the determining the target task queue from the plurality of task queues includes: generating a random weight coefficient; and determining a task queue corresponding to a weight coefficient interval within which the random weight coefficient falls as the target task queue.

17. A computer-readable storage medium, wherein the computer-readable storage medium stores computer instructions, and when the computer instructions are executed by one or more processors, the computer instructions enable the one or more processors to, individually or collectively, implement acts comprising: determining a target task queue from a plurality of task queues, the plurality of task queues configured to respectively store tasks with different priorities, each task queue having a respective scheduling weight, and the scheduling weight related to a probability that the task queue is determined as the target task queue; and scheduling a target task in the target task queue to a thread in a thread pool, to execute the target task.

18. The computer-readable storage medium according to claim 17, wherein the thread pool includes a first thread and a second thread, and the first thread and the second thread are configured respectively to execute tasks with different priorities; and the scheduling the target task in the target task queue to the thread in the thread pool includes: scheduling the target task to one of the first thread or the second thread based on a priority of the target task.

19. The computer-readable storage medium according to claim 18, wherein the first thread is configured to execute a task with a highest priority stored in the plurality of task queues, the second thread is configured to execute a task with a priority other than the highest priority stored in the plurality of task queues, and a quantity of the first thread is less than or equal to a quantity of the second thread.

20. The computer-readable storage medium according to claim 17, where the acts comprise: preliminarily determining a total quantity of the plurality of threads; predicting, based on the total quantity of threads preliminarily determined, a total memory usage during execution of tasks stored in the plurality of task queues; and in response to the total memory usage exceeding a memory limit, reducing the total quantity of the plurality of threads until the total memory usage predicted satisfies the memory limit.
